(19) United States
(12) Patent Application Publication
(10) Pub. No.: US 2014/0150620 A1
(43) Pub. Date: Jun. 5, 2014

(54) Saw Blade Having Different Material Teeth and Method of Manufacture

(71) Applicant: IRWIN INDUSTRIAL TOOL COMPANY, Huntersville, NC (US)

(72) Inventors: Asif Elliston, Springfield, MA (US); Stephen A. Hampton, East Longmeadow, MA (US); Mark T. Cranna, Somers, CT (US); Kenneth Hall, East Longmeadow, MA (US)

(73) Assignee: IRWIN INDUSTRIAL TOOL COMPANY, Huntersville, NC (US)

(21) Appl. No.: 13/691,394

(22) Filed: Nov. 30, 2012

(51) Int. Cl. B23D 61/12; B23D 65/02; B23D 65/00

(52) U.S. Cl. CPC B23D 61/127; B23D 61/121; B23D 65/00; B23D 65/02
USPC 83/661; 83/835; 83/851; 83/848; 76/112

(57) ABSTRACT

A saw blade having a blade body, a plurality of cutting teeth defining a cutting edge along an edge of the blade body, each tooth along the cutting edge defining a cutting tip. At least one tooth tip along the cutting edge includes a different material, such as, for example, high speed steel, carbide, diamond, and/or a tip coating, than at least one other tooth tip along the cutting edge. The plurality of teeth may be arranged in a repeating pattern or in no pattern along the cutting edge. A method of manufacturing the saw blade includes forming a cutting edge along an axial edge of a blade body, defined by a plurality of cutting teeth having respective tooth cutting tips, wherein at least one tooth tip along the cutting edge includes a different material than at least one other tooth tip along the cutting edge.

### FIELD OF THE INVENTION

The present invention relates to saw blades, and more particularly, to saw blade teeth having tips including different materials, respectively.

### BACKGROUND OF THE INVENTION

A typical toothed saw blade includes a blade portion having a cutting edge defined by a plurality of teeth axially or circumferentially spaced relative to each other along one side of the blade. A “one-sided” blade has a non-working edge formed on an opposite side of the blade relative to the cutting edge, while a “double-sided” blade will have two opposing cutting edges. In addition to the configuration of the saw blade itself, e.g., tooth profile, the blade materials are selected based on an intended application and/or desired durability. Generally, though, the use of stronger and/or more durable materials involves increased cost and/or increased manufacturing complexity. Further these “upgraded” materials may present trade-offs for their increased strength/durability.

One blade configuration, for example, that has gained wide acceptance as having increased performance and durability with an acceptable cost differential is a composite or bi-metal (or tri-metal in the case of double-sided blades) blade. A typical bi-metal saw blade includes a spring or carbon steel blade body having a cutting edge or teeth formed of high speed or tool steel. The use of high speed or tool steel only at the cutting edge limits cost. The use of carbon or spring steel for the blade body helps maintain flexibility and toughness of the blade.

Though bi-metal blades can provide substantial performance improvements over carbons steel blades, some applications require even greater cutting ability and/or durability. For such applications, such as abusive applications, specialty blades are used. As compared to bi-metal blades, specialty blades, on the other hand, may have a cutting edge or include teeth made of different material. For example, specialty blades may include diamond or carbide tipped teeth rather than the high speed steel used on typical bi-metal saw blades. Such higher strength, higher hardness, higher durability materials can provide increased cutting speed and blade life over even bi-metal blades in certain applications or when cutting certain materials.

Though a specialty blade can be very beneficial when used for an intended application, both for its cutting efficiency and for its blade life, there can be trade-offs. A specialty blade can be more susceptible to premature failure than a typical saw blade when misapplied. For example, when cutting through an abrasive material, which tends to dull the blade relatively quickly, a carbide-tipped specialty blade is very advantageous because the carbide tipped teeth remain sharp for longer. However, the carbide material at the tip of these blades possesses a higher hardness than a typical bi-metal blade, and consequently is more brittle. Thus, inadvertent misapplication or misuse by a user, such as, for example, cutting through a hard material, such as a nail or screw, or where an impact occurs, is more likely to cause the teeth to break or even catastrophic failure of the blade than with a typical bi-metal blade. Vibration of the saw blade when cutting, as is not atypical, for example, with reciprocating saw blades, can similarly cause the carbide-tipped teeth to break.

Another issue with specialty-type blades is cost. They are much more expensive to produce than even bi-metal blades. The above-described potential breakage problem is exacerbated by this cost of manufacture, and thus the retail cost, of a specialty blade relative to a typical blade. Consequently, breakage due to just a small error in the blade's application, or premature failure or wear of the blade, is of significant financial consequence to the user.

Prior art attempts to solve the problem include the use of lower grade material, e.g., lower grade carbide, to reduce costs. While less expensive, these blades are also less durable. Other attempts have involved highly sophisticated manufacturing processes in an attempt to reduce blade manufacturing costs. Nonetheless, costs remain higher to manufacture such specialty blades in comparison to a typical bi-metal blade.

### SUMMARY OF THE INVENTION

It is an object of the present invention to overcome one or more of the above-described drawbacks and/or disadvantages of the known saw blades.

In one aspect, a saw blade comprises a blade body, a plurality of cutting teeth defining a cutting edge along an edge of the blade body, each tooth along the cutting edge defining a cutting tip, wherein at least one tooth tip along the cutting edge includes a first material and at least one other tooth tip along the cutting edge includes a second material different than the first material.

In some embodiments, the saw blade is a reciprocating saw blade for use in a reciprocating saw machine. As should be understood by those of ordinary skill in the art, a reciprocating saw machine is a hand-held power saw that includes a chuck for releasably engaging a tang extending from the end of the saw blade and driving the saw blade in a reciprocating motion through a work piece. The reciprocating motion can be an orbital cutting action, a straight or linear cutting action, or an angled cutting action. The length or stroke of the reciprocating motion is typically about 1½ inches or less. Reciprocating saws typically are driven by electric motors (e.g., cord or cordless saws) or are pneumatically driven. A typical reciprocating saw blade includes a blade portion having a cutting edge defined by a plurality of teeth axially spaced relative to each other along one side of the blade, and a non-working edge formed on an opposite side of the blade relative to the cutting edge. A tang for releasably connecting the blade to the chuck of a reciprocating saw extends from an inner end of the blade.

In some other embodiments, the saw blade is a band saw blade. In yet other embodiments, the saw blade is a hole saw blade. In further embodiments, the saw blade is a hack saw blade.

In some embodiments, the first material includes high speed or tool steel. In some embodiments, the second material includes a carbide material. In some embodiments, the second or different material includes diamond. In some embodiments, the at least one of the materials includes a coating. In some such embodiments, the coating is one of a physical vapor deposition coating, a ceramic coating a metal nitride coating, and a carbide-containing coating.

In some embodiments, the plurality of cutting teeth are arranged in a repeating pattern along the cutting edge, said pattern comprising a tooth having a tip including the first material, followed by a tooth having a tip including the second material.

In some embodiments, the plurality of cutting teeth are arranged in a repeating pattern along the cutting edge, said pattern comprising a tooth having a tip including the first material, followed by a pair of teeth having tips including the second material.

In some embodiments, the plurality of cutting teeth are arranged in a repeating pattern along the cutting edge, said pattern comprising a pair of teeth having tips including the first material, followed by a pair of teeth having tips including the second material.

In accordance with another aspect, a saw blade comprises a blade body, a plurality of cutting teeth defining a cutting edge along an end of the blade body, each tooth along the cutting edge having a first means for cutting, wherein at least one of the first means for cutting includes a first material and at least one other of the first means for cutting includes a second material different than the first material.

In some embodiments, the first means for cutting defines a cutting tip of a respective cutting tooth.

In accordance with another aspect, a method of manufacturing a saw blade comprises the steps of:

(i) forming a saw blade body; and

(ii) forming, along an axial edge of the saw blade body, a plurality of cutting teeth having respective tooth cutting tips defining a cutting edge of the saw blade, wherein at least one tooth tip along the cutting edge includes the first material and at least one other tooth tip along the cutting edge includes a second material different than the first material.

In some embodiments, the step of forming the saw blade body includes attaching a wire comprising the first material along an axial edge of a backing strip; and the step of forming the plurality of cutting teeth comprises forming the teeth along the edge of the saw blade body including the first material.

In some embodiments, the step of forming the plurality of teeth comprises forming the at least one tooth tip including the first material from the saw blade body, forming, at a location of the at least one other tooth tip, a surface on the saw blade body adapted to receive a tooth tip including the second material, and attaching a tooth tip including the second material to said surface to form the at least one other tooth tip.

In some embodiments, the forming step comprises die cutting the blade body to form the plurality of cutting teeth. In some embodiments, the forming step comprises machining the blade body to form the plurality of cutting teeth.

Objects and advantages of the present invention, and/or of the currently preferred embodiments thereof, will become more readily apparent in view of the following detailed description of the currently preferred embodiments and accompanying drawings.

### BRIEF DESCRIPTION OF THE DRAWINGS

FIG. 1 is a partial, side elevational view of a saw blade defining a repeating pattern of cutting teeth along a cutting edge, wherein a single tooth having a tip including a first material alternates with a pair of teeth having tips including a second, different, material;

FIG. 2 is a partial, side elevational view of a saw blade defining a repeating pattern of cutting teeth along a cutting edge, wherein a pair of teeth having a tip including a first material alternates with a pair of teeth having tips including a second, different, material; and

FIG. 3 is a partial, side elevational view of a saw blade defining a repeating pattern of cutting teeth along a cutting edge, wherein a single tooth having a tip including a first material alternates with a single tooth having a tip including a second, different, material.

### DETAILED DESCRIPTION OF EMBODIMENTS OF THE INVENTION

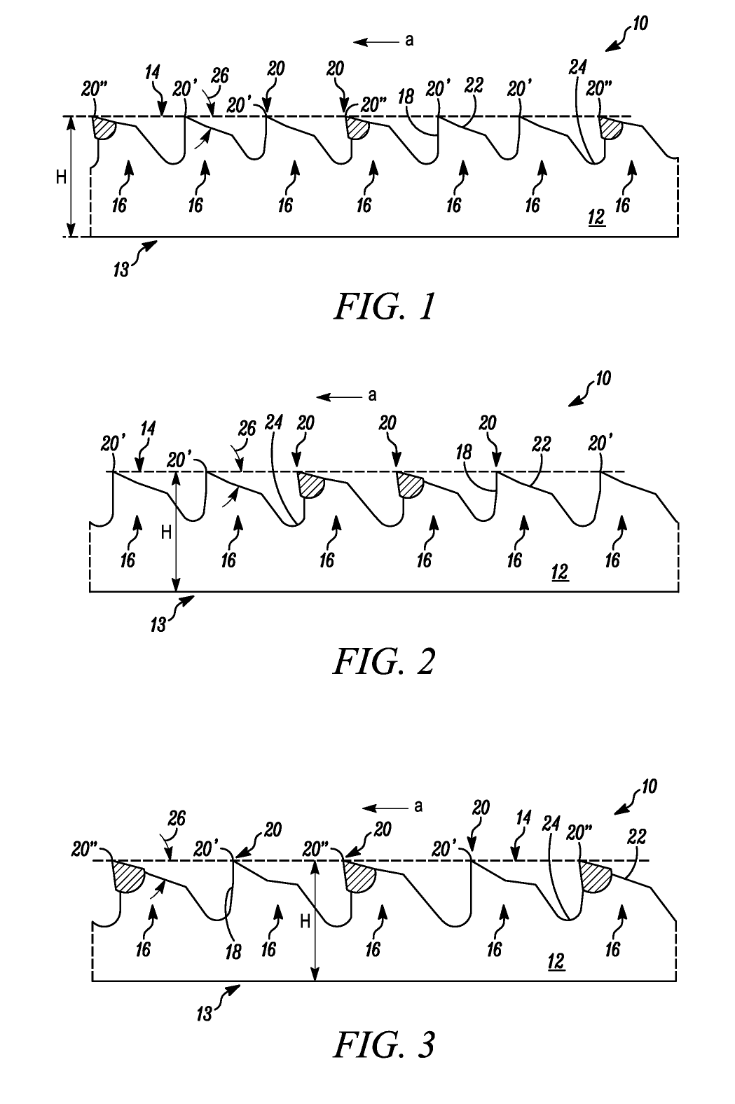

In FIG. 1, a saw blade is indicated generally by the reference numeral 10. In the shown embodiment, the saw blade 10 is a reciprocating saw blade. The saw blade 10 comprises a generally elongated blade body 12, made of, for example, spring or carbon steel, having a back edge 13 and an opposing cutting edge 14 defined by a plurality of cutting teeth 16, in this embodiment a repeating pattern of teeth. As may be recognized by those of ordinary skill in the pertinent art based on the teachings herein, the saw blade 10 may equally take the form of another type of saw blade, currently known or that later becomes known, such as, for example a hole saw, band saw, or hack saw blade.

As shown in FIG. 1, each tooth 16 includes a rake face 18, a tip 20, a primary clearance surface 22 on the opposite side of the tip 20 relative to the rake face 18, and a gullet 24. The primary clearance surface 22 defines a primary clearance angle 26 between the primary clearance surface and a plane parallel to the cutting edge 14. As shown in FIG. 1, the forward or cutting direction of the blade is indicated by the arrow “a.”

Though the teeth 16 in the embodiments of FIGS. 1-3 have the shown configurations, it should be understood by those of ordinary skill in the art that the teeth may have different configurations, according to the intended blade application, as is known or is later developed.

By way of example only, the teeth 16 may also have secondary and/or tertiary clearance surfaces defining secondary and/or tertiary clearance angles, such as, but not limited to, that disclosed in U.S. patent application Ser. No. 12/776,145, filed May 7, 2010, entitled “Recip Blade with Robust Tooth Form,” which is hereby expressly incorporated by reference in its entirety as part of the present disclosure.

As another example, the different teeth 16 along the cutting edge 14 may define variable heights, such as, but not limited to, that disclosed in U.S. Pat. No. 8,210,081, issued Jul. 3, 2012, entitled “Reciprocating Saw Blade Having Variable Height Teeth and Related Method,” which, in turn, claims priority from similarly titled U.S. Provisional Patent Application Ser. No. 60/934,262, filed Jun. 12, 2007, each of which is hereby expressly incorporated by reference in its entirety as part of the present disclosure. The height H of a tooth 16 in the shown embodiments is measured as the distance between a tip 20 of a respective tooth and a selected reference plane of the blade body 12 located below the tips 20, such as, for example, the back edge 13. Typically, heights are measured with respect to a back edge of the saw blade 10; however, as may be recognized by those of ordinary skill in the pertinent art based on the teachings herein, the heights can be measured with respect to any of numerous different reference points that are currently known or used, or later become known or used for this purpose.

As yet another example, the teeth 16 may define a plurality of repetitive patterns of teeth, i.e., tooth patterns that have variable heights, clearance angles, rake angles and/or set, according to the intended application as should be understood by those of ordinary skill in the art, for example, as disclosed in, but not limited to, U.S. patent application Ser. No. 12/827,658, filed Jun. 30, 2010, entitled “Saw Blade Tooth Form For Abusive Cutting Applications,” which is hereby expressly incorporated by reference in its entirety as part of the present disclosure.

Different tips 20 along the cutting edge 14 of the blade 10 include different materials. As shown in FIGS. 1-3, the tips 20′ include a first material and the tips 20″ (depicted as fully shaded) include at least one different second material. For example, the tips 20′ may be high speed steel (HSS) tips and the tips 20″ carbide. Exemplary carbides include tungsten carbide (WC) and titanium carbide (TiC). However, any suitable carbide may be used, as should be appreciated by those of ordinary skill in the art. In some such embodiments, the carbide tips 20″ may all include substantially the same type or grade of carbide. In other such embodiments, different carbide tips 20″ may include different types or grades of carbide, such as, by way of example only, type/grade A and type/grade B carbides. As another example, the tips 20′ may be high speed steel tips and the tips 20″ may include a composite ceramic and metal material (“cermet”). As yet another example, the tips 20′ may be high speed steel tips and the tip 20″ diamond or diamond coated. In other embodiments, the tips 20′ are a different type of steel than the tips 20″. For example, the tips 20′ may be carbon steel and the tips 20″ high speed or tool steel. As yet another example, the tip 20′ may not have any coating thereon, and the tips 20″ may be coated. In such embodiments, the tips 20″ may be coated with any of numerous different coatings that are currently known or that later become known. Non-limiting examples of such coatings include a PVD (physical vapor deposition) coating, a ceramic coating, a metal nitride coating, such as, for example, titanium nitride (TiN), aluminum titanium nitride (AlTiN), chrome nitride (CrN), or zirconium nitride (ZrN), a carbide-containing coating, such as, for example, titanium carbide (TiC), titanium carbonitride (TiCN), aluminum titanium carbonitride (AlTiCN), or zirconium carbonitride (ZrCN), or combinations thereof, which are also disclosed in U.S. Pat. No. 7,712,222, issued May 11, 2010, entitled “Composite Utility Blade, and Method of Making Such a Blade,” which is a continuation-in-part of similarly-titled U.S. patent application Ser. No. 10/202,703, filed Jul. 24, 2002, which is a continuation-in-part of similarly-titled U.S. Pat. No. 6,701,627, issued May 9, 2004, and claims the benefit of similarly-titled U.S. Provisional Patent Application Ser. No. 60/451,985, filed Mar. 5, 2003, and also in U.S. Pat. No. RE43,287, issued Apr. 3, 2012, entitled “Multi-Chip Facet Cutting Saw Blade and Related Method,” which is a reissue of similarly titled U.S. Pat. No. 7,131,365, issued Nov. 7, 2006, which, in turn, claims priority from similarly titled U.S. Provisional Patent Application Ser. No. 60/503,338, filed Sep. 16, 2003, each of which is hereby expressly incorporated by reference in its entirety as part of the present disclosure. As should be recognized by those of ordinary skill in the pertinent art based on the teachings herein, different teeth 16 along the cutting edge 14 may have tips 20 including any of numerous different materials, respectively, currently known, or that later become known, according to the intended application of the saw blade 10. As also may be recognized by those of ordinary skill in the art based on the teachings herein, the different tips 20 of the teeth 16 along the cutting edge 14 may include more than two different materials, respectively, according to the intended application of the saw blade. For example, the tips 20 can contain three or more different materials, coatings, or combinations thereof.

The teeth 16 may also be arranged in different patterns along the cutting edge 14, according to the material of their respective tips 20. For example, as shown in FIG. 1, a single tooth 16 having tip 20″ including a first material alternates between pair of teeth 16 having tips 20′ including a different second material. As another example, as shown in FIG. 2, a pair of teeth 16 having tips 20′ including a first material, respectively, alternate with a pair of teeth 16 having tips 20″ including a different second material, respectively. Alternatively, as shown in FIG. 3, a single tooth 16 having a tip 20′ including a first material alternates with a single tooth 16 having tip 20″ including a second different material. However, as may be recognized by those of ordinary skill in the pertinent art based on the teachings herein, the teeth 16, having tips 20 including different materials, respectively, may be arranged along the cutting edge 14 in any of numerous different arrangements and/or patterns, currently known, or that later become know, according to the intended application of the saw blades 10. In alternative embodiments, the teeth may define no pattern with respect to the materials of the tips, or define a random pattern.

Further, though in FIGS. 1-3 the back edge 13 does not have a cutting edge, in other embodiments the back edge 13 defines a cutting edge. In addition, such cutting edge in some embodiments is substantially identical to the cutting edge 14, and in other embodiments it is different. It can be different with respect to any of one or more features, including but not limited to, pitch, tooth shape, tooth height, tooth size, tooth set, rake angle, clearance angle(s), gullet depth or shape, materials, and/or tooth pattern or lack thereof, etc., as will be understood by those of ordinary skill in the art.

The current invention provides significant advantages over known saw blades. From a cost perspective, the inventors have found that a reduced number of specialty or higher-grade material tips may be utilized in a blade while still efficiently cutting the intended material. As the cost of a specialty tip material, such as, for example, carbide or diamond, is much more expensive than the cost of a typical steel tip or steel-tipped blade, even when a bi-metal construction is used, reducing the number of tips including specialty blade material will, at a minimum, reduce the manufacturing cost of blades of the invention. Accordingly, the retail cost of such blades will also be reduced.

The current inventors have also found that in addition to reducing the manufacturing costs of blades of the invention, as a result of the reduced number of tips including specialty blade material, for example, the resultant blades are also more versatile. For example, as discussed above, a blade having only high speed steel tooth tips will wear relatively quickly when cutting through an abrasive work piece in comparison to a carbide tipped blade. On the other hand, the blade having only carbide tipped teeth may perform relatively poorly, and may chip fracture, when cutting a hard material, such as a nail or screw, or subject to impact or vibration. However, the current inventors have found that a saw blade 10 having different tips 20′, 20″, including different materials, respectively, performs substantially well, i.e., cuts efficiently, is durable, and/or meets expected blade life, in a variety of applications, and a wider variety of applications than traditional for specialty blades. For example, a blade having an arrangement of both high speed steel tipped teeth and carbide tipped teeth will perform substantially well when cutting through either of the abrasive and/or a hard material work surfaces mentioned, at substantially reduced costs as compared to a blade having only carbide teeth. The high speed steel teeth will cut through the harder material and reduce impact and breakage of the carbide teeth, and the carbide teeth will efficiently cut the abrasive material, reducing the workload and subsequent wear to the high speed tips.

The blades 10 of the invention are manufactured by forming a cutting edge 14 defined by a plurality of cutting teeth 16 along an axial edge of a blade body 12, where different tips 20 of the teeth 16 along the cutting edge 14 include different materials. In many embodiments, the blades are formed using known techniques or a combination of known techniques for making previously-known blades of the selected materials, as should be understood by those of ordinary skill in the art. For example, in embodiments having a combination of high speed steel and carbide tips, the high speed steel tips can be formed using known techniques, and the carbide tips can be formed by using known techniques for doing so.

In one such embodiment, a bi-metal or composite blade strip is first formed by welding a wire of a first material along an axial edge of a backing strip of a second material and heat treating the blade strip in a known manner. In some such embodiments the second material of the backing strip is a metal, such as steel. In some such embodiments, the steel is, for example, spring steel or carbon steel. In some embodiments, the first material of the wire is a metal, such as, for example a high speed or tool steel. However, as may be recognized by those of ordinary skill in the pertinent art based on the teachings herein, any of numerous different materials for the wire and the backing strip, currently known, or that later become known, may be used according to the intended application of the blades. As also may be recognized by those of ordinary skill in the pertinent art based on the teachings herein, a unitary structure blade strip made of a single material, such as, for example, a metal (e.g. spring steel or carbon steel), or a composite material may be utilized to manufacture the blades 10. Alternatively, a tri-metal blade strip may be utilized to manufacture the blades 10 having cutting edges along opposing sides of the blade body.

Individual blade bodies 12 are then die cut or otherwise formed from the unitary or bi-metal blade strip. The plurality of cutting teeth 16 are then machined, such as, for example, milled, cut, punched, ground, or otherwise formed along the edge of the blade bodies 12 having the first material. In some embodiments, the blade bodies 12 are die cut to form the teeth 16. In other embodiments, the blade bodies 12 are mounted in a fixture, and the blade bodies 12 are machined to form the teeth 16, as disclosed in U.S. Provisional Patent Application Ser. No. 61/666,724, filed Jun. 29, 2012, entitled “Double Sided Hand Hack Saw Blade and Method of Manufacture,” which is hereby expressly incorporated by reference in its entirety as part of the present disclosure.

The teeth 16 are formed, i.e., shaped, according to the desired tooth tip material as well as the tooth pattern along the cutting edge 14. For example, where a blade is desired that has select tooth tips including specialty material(s), such as, for example, carbide or diamond, the select teeth intended to have the specialty material at the tip can be initially formed without a tip, but instead are formed with a pocket at the top of the tooth, i.e., a surface at the top of the tooth for receiving a tooth tip, in accordance with the standard methods known by those of ordinary skill in the pertinent art. Thereafter, tips having the specialty material are joined, e.g., welded, onto those select teeth with pockets in accordance with the standard methods known by those of ordinary skill in the pertinent art.

By way example only, if the desired saw blade has a spring steel backing with alternating teeth tips 20′ and 20″, such as shown in FIG. 3, that include high speed steel and carbide, respectively, a high speed steel wire would first be welded onto an axial edge of a spring steel backing strip, and formed into individual blade bodies 12. Thereafter, teeth 16 would be formed in the high speed steel edge of the blade body 12, having alternating teeth with high speed steel tips 20′ and teeth having pockets at the top of the tooth. Then, carbide tips 20″ would be welded onto the alternating teeth with pockets, resulting in a blade 10 having teeth with alternating tips of high speed steel and carbide. In such manner, blades can be manufactured using the known, relatively low cost procedures for manufacturing bi-metal blades, modified to add carbide tips to selected teeth tips. In certain embodiments, preformed carbide tips are used limit costs.

Alternatively, all of the tooth forms can be provided with a pocket for attachment of a tip. For example, if a carbon or spring steel blade body 12 is used, a pocket can be created for each tooth 16, and tooth tips 20 of desired materials or combinations of materials, e.g., HSS, carbide, cermet, diamond, etc., can be attached to form the tip of tooth. In such embodiments, the preliminary step of forming the bi-metal strip, e.g. welding a wire or strip to the carbon or spring steel backing is thereby eliminated. Such embodiments also eliminate the need for more complex tooling and machining operations in which only certain of the teeth are machined to form pockets.

On the other hand, the blade can be made without forming any pockets. Rather, a tooth form with a tip can be made in the initial teeth-forming operation (e.g., milling, punching, grinding, etc.), and then other materials attached to selected teeth. As should also be recognized by those of ordinary skill in the pertinent art, the tooth tip material(s) may equally be welded, or otherwise deposited, such as, for example, via coating, onto teeth 16 formed with tips, i.e., not formed with preformed pockets.

As discussed above, and as those of ordinary skill in the art should appreciate, different teeth intended to receive specialty material(s) (i.e., different than the base material of the blade body) may each receive the same grade specialty material, or different grades of the specialty material. For example, and without limitation, some of the selected teeth 16 may receive type/grade A carbide tips while other of the selected teeth may receive type/grade B carbide tips. As should also be recognized by those of ordinary skill in the pertinent art, select teeth may receive other tooth tip material(s), such as, for example, high speed steel or a cermet composite material.

As may be recognized by those of ordinary skill in the pertinent art based on the teachings herein, numerous changes and modifications may be made to the above-described and other embodiments without departing from the scope of the invention as defined in the appended claims. For example, the tooth forms and patterns may differ from the tooth forms and patterns described herein. Certain tooth forms may be removed, and other different tooth forms may be added, and/or the teeth of the repeating pattern may all define the same tooth form, such as a straight-backed tooth form that defines a single clearance surface, or a tooth form that defines three or more clearance surfaces. Similarly, the teeth may define different pitches, different set patterns, and different combinations of set patterns and tooth heights. For example, the teeth need not define any height differentials and/or the teeth may define varying degrees of set magnitude (including heavy and light sets, and other degrees of set). As another example, the teeth having tips including a first material can be set in the same direction and to the same set magnitude as the teeth having tips including a different second material. Alternatively, the teeth having tips including a first material may be set to a different magnitude and/or direction than the teeth having tips including a different second material. As yet another example, high teeth may include a relatively heavy set magnitude and low teeth may define a relatively light set magnitude as compared to the high teeth. Similarly, the rake face of the teeth may be substantially vertical (i.e., 0° rake) or define a rake angle (e.g., a positive or negative rake angle). As another example, the teeth may be arranged at a variable pitch or a constant pitch. As yet another example, any other clearance angles, tooth heights, gullet radii and rake face depths that are known, or that later become known, and different than those described herein equally may be employed. As yet another example, teeth having tips including a first material may be unset and the teeth having tips including a different second material may be set. As yet another example, the back edge of the saw blade may also define a cutting edge, defining a plurality of teeth configured as described above. Accordingly, this detailed description of currently preferred embodiments is to be taken in an illustrative, as opposed to a limiting sense.

What is claimed is:

1. A saw blade comprising:
a blade body, a plurality of cutting teeth defining a cutting edge along an edge of the blade body, each tooth along the cutting edge defining a cutting tip,
wherein at least one tooth tip along the cutting edge includes a first material and at least one other tooth tip along the cutting edge includes a second material different than the first material.

2. A saw blade as defined in claim 1, wherein the saw blade is a reciprocating saw blade including at least one tang adapted for engaging a corresponding chuck of a reciprocating saw.

3. A saw blade as defined in claim 1, wherein the saw blade is a band saw blade, a hole saw blade, or a hack saw blade.

4. A saw blade as defined in claim 1, wherein the first material includes high speed steel.

5. A saw blade as defined in claim 1, wherein the second material includes at least one of (i) a carbide material, (ii) a cermet composite material and (iii) a diamond material.

6. A saw blade as defined in claim 1, wherein the second material includes a coating.

7. A saw blade as defined in claim 6, wherein the coating is one of a physical vapor deposition coating, a ceramic coating a metal nitride coating, and a carbide-containing coating.

8. A saw blade as defined in claim 1, wherein the first material includes high speed steel, and the second material includes at least one of (i) at least one grade of a carbide material and (ii) a diamond material.

9. A saw blade as defined in claim 1, wherein the plurality of cutting teeth are arranged in a repeating pattern along the cutting edge, said pattern comprising a tooth having a tip including the first material, followed by a tooth having a tip including the second material.

10. A saw blade as defined in claim 1, wherein the plurality of cutting teeth are arranged in a repeating pattern along the cutting edge, said pattern comprising a tooth having a tip including the first material, followed by a pair of teeth having tips including the second material.

11. A saw blade as defined in claim 1, wherein the plurality of cutting teeth are arranged in a repeating pattern along the cutting edge, said pattern comprising a pair of teeth having tips including the first material, followed by a pair of teeth having tips including the second material.

12. A saw blade comprising:
a blade body, a plurality of cutting teeth defining a cutting edge along an end of the blade body, each tooth along the cutting edge having a first means for cutting,
wherein at least one of the first means for cutting includes a first material and at least one other of the first means for cutting includes a second material different than the first material.

13. A saw blade as defined in claim 12, wherein the first means for cutting defines a cutting tip of a respective cutting tooth.

14. A method of manufacturing a saw blade comprising the steps of:
forming a saw blade body; and
forming, along an axial edge of the saw blade body, a plurality of cutting teeth having respective tooth cutting tips defining a cutting edge of the saw blade, wherein at least one tooth tip along the cutting edge includes the first material and at least one other tooth tip along the cutting edge includes a second material different than the first material.

15. A method as defined in claim 14, wherein
the step of forming the saw blade body includes attaching a wire comprising the first material along an axial edge of a backing strip; and
the step of forming the plurality of cutting teeth comprises forming the teeth along the edge of the saw blade body including the first material.

16. A method as defined in claim 14, wherein the step of forming the plurality of cutting teeth comprises forming the at least one tooth tip including the first material from the saw blade body.

17. A method as defined in claim 14, wherein the step of forming the plurality of cutting teeth comprises:
forming, at a location of the at least one other tooth tip, a surface on the saw blade body adapted to receive a tooth tip including the second material; and
attaching a tooth tip including the second material to said surface to form the at least one other tooth tip.

18. A method as defined in claim 14, wherein the first material includes a metal.

19. A method as defined in claim 14, wherein the second material includes at least one of (i) a carbide material, (ii) a cermet composite material and (iii) a diamond material.

20. A method as defined in claim 14, wherein the second material includes a coating.

21. A method as defined in claim 14, wherein the step of forming the plurality of cutting teeth comprises die cutting the blade body.

22. A method as defined in claim 14, wherein the step of forming the plurality of cutting teeth comprises machining the blade body.
